(19) United States
(12) Patent Application Publication
(10) Pub. No.: US 2024/0254355 A1
(43) Pub. Date: Aug. 1, 2024

(54) COLOR-CHANGE MARKING SYSTEM

(71) Applicant: Crayola LLC, Easton, PA (US)

(72) Inventor: Keith John Allison, Blandon, PA (US)

(73) Assignee: Crayola LLC, Easton, PA (US)

(21) Appl. No.: 18/101,880

(22) Filed: Jan. 26, 2023

(51) Int. Cl. C09D 11/50; C09D 11/54

(52) U.S. Cl. CPC C09D 11/50; C09D 11/54

(57) ABSTRACT

The marking system includes one or more ink compositions and a color-change agent composition. The ink composition applied to a substrate such that it is a first color, but when a color-change agent is applied, one or more secondary colors appear. The ink compositions each have a respective ink color and include a respective: at least one first dye composition having a respective first color and at least one second dye composition having a respective second color. The first dye composition can react with the color-change agent composition. When the color-change agent composition contacts the ink composition, each respective first dye composition reacts with the color-change agent composition, 10 thereby producing each respective second color. Each respective first color is different from each respective second color, and each respective second color is different from each respective ink color.

### FIELD OF THE INVENTION

The present invention relates to coated substrates, and more particularly to a system where a coating on a substrate can be reacted to change from a first color to a second color by applying a color-change agent fluid to the coating.

### BACKGROUND

Many craft or art systems are available that are directed to children. One such system is described in U.S. Pat. No. 7,521,112. The technology of the '112 patent relies on a thick black opaque coating layer to be applied over printed colored designs on special paper. The black coating is readily removed with water and can undesirably stain users’ hands if they are moist. The black coating of the '112 patent is also difficult to produce and also requires a great deal of dye in order to provide opacity.

In addition to minimizing these issues and shortcomings, it is important to maintain a pH of any of the components in such marking systems such that the pH is not dangerously high or low, so as not to irritate a user's skin. Therefore a need remains for a color-change system that is not messy to make and use and also provides improved performance and longevity and is not limited to a special paper and that has a pH within a safe range.

### SUMMARY

The inventor has discovered a new method that mitigates the aforementioned problems. The present marking system eliminates the need for the messy black topcoat and allows for the use of any type of paper. The present system is a marker-paper image reveal system using printing inks made with different dye combinations to produce several versions of a single, secondary color. Upon marking with the color-change agent marker ink, the different print inks react (change color), from that single starting color to a primary color to reveal a multi-colored, primary pattern in the print ink coating. Accordingly, the ink formulations change color upon contact with the color-change agent composition. According to an embodiment, three black printing ink formulations that each turn a different color upon reaction with a color-change agent marker ink: black-to-cyan, black-to-magenta and black-to-yellow are provided. These three ink formulations are spot-printed on paper in either a repeated pattern or a random pattern or to form an image that is revealed when colored on with the colorless, color-change agent ink. In addition, the pH of the color-change agent composition may less than 14. Thus, a substrate that is coated with a uniform black (or other color) coating is written on or marked with the colorless color-change agent ink will change to one or more colors other than black.

A marking system comprising a) a color-change agent composition and b) one or more ink compositions is provided. The one or more ink compositions each have a respective ink color. These respective ink colors may be the same or different from each other. Preferably, the respective ink colors are initially the same. According to an embodiment, the respective ink colors are all black. Each of the one or more ink compositions comprises a respective i) at least one first dye composition characterized by a respective first color; and ii) at least one second dye composition characterized by a respective second color. When the a) color-change agent composition contacts the b) one or more ink compositions, each respective i) at least one first dye composition reacts with the a) color-change agent composition, thereby producing each respective second color. Each respective first color is different from each respective second color, and each respective second color is different from each respective ink color. Each respective i) first dye composition is configured to react with the a) color-change agent composition and each respective ii) second dye composition is configured to not react with the a) color-change agent composition.

Also provided is a method of marking a substrate with the marking system. The method comprises the following steps.
A) Providing the substrate comprising an ink layer formed from the b) one or more ink compositions and having a respective ink color; and
B) applying the a) color-change agent composition to at least a portion of the ink layer to react with each respective i) first dye composition to produce the respective second color, different from each respective ink color.

### DETAILED DESCRIPTION

The present invention uses color-changing ink compositions as process ink by creating all black inks (or another initial color) that include a mixture of cyan (blue), magenta (red) and yellow dyes. According to an embodiment, each black ink is initially black (or another color) before contacting the color-change agent composition. Importantly, each black ink is a different mixtures of dyes; some of the dyes in the ink composition mixture react with the color-change agent composition to either become colorless or to intensify in color. Others of the dyes in the ink composition do not react with the color-change agent composition. So, for example, the “cyan color change ink” is a mixture of cyan (blue), magenta (red) and yellow dyes that appears black. In this example, the magenta (red) and yellow dyes react with the color-change agent and lose their color, while the cyan (blue) dye does not react with the color-change agent. When the color-change agent composition contacts the initially black ink composition, the red/magenta and yellow used to make it black are rendered colorless, thus leaving the blue/cyan behind. When the eradicating marker is used on the spot where that process ink is printed, the black transforms into cyan/blue. This same principle, with different dyes, is used to prepare ink compositions that all are initially black (for example), but when contacted with the color-change agent, turn red or yellow. When all of these different black inks are spot-printed on a substrate, e.g., paper, the paper appears uniformly black. When the color-change agent composition is applied to the black ink, different colors are revealed depending on the particular dye composition used for each black ink composition.

The marking system therefore is a color change system using printing ink compositions made with different dye combinations to produce several versions of a single, secondary color. Upon marking with the color-change agent composition (applied with, for example, a marker containing the color-change agent composition, or applied with a brush, or other method), the different print ink compositions react (change color), from that single starting color to a primary color to produce a multi-colored, primary pattern in the print ink coating

Thus, a marking system comprising a) a color-change agent composition and b) one or more ink compositions is provided. The one or more ink compositions each have a respective ink color. These respective ink colors may be the same or different from each other. Preferably, the respective ink colors are the same. According to an embodiment, respective ink colors are all black. Each of the one or more ink compositions comprises a respective i) at least one first dye composition characterized by a respective first color; and ii) at least one second dye composition characterized by a respective second color. When the a) color-change agent composition contacts the b) one or more ink compositions, each respective i) at least one first dye composition reacts with the a) color-change agent composition, thereby producing each respective second color. Each respective first color is different from each respective second color, and each respective second color is different from each respective ink color. Each respective i) first dye composition is configured to react with the a) color-change agent composition and each respective ii) second dye composition is configured to not react with the a) color-change agent composition.

### a) Color-Change Agent Composition:

According to an embodiment, the a) color-change agent composition comprises iii) at least one solvent. Non-limiting examples of suitable solvents are water, C1-C5 alcohols, or combinations thereof. According to an embodiment, the a) color-change agent composition is aqueous, i.e., the solvent iii) comprises water. The a) color-change agent composition may comprise from 40 wt % to 95 wt % solvent, based on the total weight of the a) color-change agent composition. The a) color-change agent composition may comprise at least 40, 45, 50, 55, 60, 65, 70, 75, 80, 85 or at least 90 wt % solvent, based on the total weight of the a) color-change agent composition. The color-change agent composition may comprise at most 98, 95, 90, 85, 80, 75, 70, 65, 60, 55, 50 or at most 45 wt % solvent, based on the total weight of the a) color-change agent composition.

According to another embodiment, the a) color-change agent composition is disposed in an applicator. The applicator may be in the form of a pen, or a marker, or a crayon, for example. The color-change agent may be applied by a brush or a finger, according to other embodiments.

According to an embodiment, the a) color-change agent composition comprises iv) at least one agent reactive with the i) at least one first dye composition. These agents reactive with the i) at least one first dye composition may be water soluble reducing salts. Non-limiting examples of suitable agents are sodium sulfite, potassium sulfite, sodium bisulfite, potassium bisulfite, sodium metabisulfite, potassium metabisulfite, sodium dithionite, potassium dithionite, sodium hydrosulfite, potassium hydrosulfite, sodium formaldehyde sulfoxylate or zinc formaldehyde sulfoxylate, or combinations thereof. According to an embodiment, suitable reactive agents include sodium sulfite, potassium sulfite, or combinations thereof. The a) color-change agent composition may comprise from 1 wt % to 25 wt % of the reactive agent, based on the total weight of the a) color-change agent composition. The a) color-change agent composition may comprise at least 1, 2, 3, 4, 5, 6, 7, 8, 9, 10, 11, 12, 15, 18, 20, or at most 22 wt % of the reactive agent, based on the total weight of the a) color-change agent composition. From a practical standpoint, the limitation of the amount of the reactive agent is limited by its solubility in the solvent, which is preferably water.

According to another embodiment, the a) color-change agent composition further comprises: v) at least one pH adjuster. Non-limiting examples of suitable pH adjusters are acids, bases, and combinations thereof. Particular examples are sodium hydroxide, potassium hydroxide, calcium hydroxide, lithium hydroxide, citric acid, acetic acid, lactic acid, formic acid, oxalic acid, uric acid, malic acid, tartaric acid, alkyl amines (e.g., C1-C3 amines), pyridine, imidazole, benzimidazole, histidine, guanidine, hydroxides of quaternary ammonium cations, or combinations thereof. According to an embodiment the pH adjuster comprises sodium hydroxide, citric acid, or a combination thereof. Suitable amounts of the pH adjusters are added to adjust the pH of the color-change agent composition to be from 8-14. The pH of the a) color-change agent composition may be at least 8. For example the pH of the a) color-change agent composition may be at least 8, 9, 10, 11, 12, or at least 13. The pH of the color-change agent composition may be at most 10-14. For example, the pH of the color-change agent composition may be at most 14, 13, 12, 11, or at most 10.

According to an embodiment, the a) color-change agent composition further comprises vi) at least one buffer. Non-limiting examples of suitable buffers include sodium carbonate, potassium carbonate, sodium bicarbonate, potassium bicarbonate, or combinations thereof. According to an embodiment, the vi) at least one buffer comprises sodium carbonate. Suitable amounts of the buffer(s) are added to adjust the pH of the color-change agent composition to be from 8-14, or from 9-14, or from 10-13, or from 10-12. The pH of the a) color-change agent composition may be at least 8, 9, 10, 11, 12, or at least 13. The pH of the color-change agent composition may be at most 14, 13, 12, 11, or at most 10.

According to an embodiment, a pH of the a) color-change agent composition may be 9 or higher. According to an embodiment, the pH of the a) color-change agent composition may be 10 or more.

According to an embodiment, the a) color-change agent composition further comprises: vii) at least one wetting agent. Nonlimiting examples of suitable wetting agents include 2,5,8,11-tetramethyl-6-dodecyn-5,8-diol ethoxylate, Dynol™ 604 (Evonik). As is known in the art, the purpose of the wetting agent is to lower interfacial tension of a liquid. The type of wetting agent is not particularly limited. The amount of wetting agent in the a) color-change agent composition may be from 0.2-1.5 wt %, based on the total weight of the a) color-change agent composition. The a) color-change agent composition may comprise at least 0.2, 0.3, 0.4, 0.5, 0.6, 0.7, 0.8, 0.9, 1.0, 1.1, 1.2, 1.3, or at least 1.4 wt % of wetting agent, based on the total weight of the a) color-change agent composition. The a) color-change agent composition may comprise at most 1.5, 1.4, 1.3, 1.2, 1.1, 1.0, 0.9, 0.8, 0.7, 0.6, 0.5, 0.4, or at most 0.3 wt % of wetting agent, based on the total weight of the a) color-change agent composition.

According to another embodiment, the a) color-change agent composition further comprises viii) at least one surfactant. The surfactant may comprise an aromatic sulfonate anionic surfactant. Non-limiting examples of suitable surfactants are Triton™ X-100 surfactant (Dow), Dowfax™ anionic surfactant (Dow), or combinations thereof. The type of surfactant is not particularly limited. The amount of surfactant in the a) color-change agent composition may be from 0.2-1.5 wt %, based on the total weight of the a) color-change agent composition. The a) color-change agent composition may comprise at least 0.2, 0.3, 0.4, 0.5, 0.6, 0.7, 0.8, 0.9, 1.0, 1.1, 1.2, 1.3, or at least 1.4 wt % of surfactant, based on the total weight of the a) color-change agent composition. The a) color-change agent composition may comprise at most 1.5, 1.4, 1.3, 1.2, 1.1, 1.0, 0.9, 0.8, 0.7, 0.6, 0.5, 0.4, or at most 0.3 wt % of surfactant, based on the total weight of the a) color-change agent composition.

According to some embodiments, the wetting agent and the surfactant may be the same. According to other embodiments, the wetting agent and the surfactant may be different.

According to an embodiment, the a) color-change agent composition further comprises ix) at least one humectant. The humectant serves to prevent the color-change agent composition from drying out too quickly when in use. The humectant also acts as a freeze-thaw stabilizer, to broaden the storage temperature range of the color-change agent composition. Non-limiting examples of suitable humectants are glycerin, ethylene glycol, diethylene glycol, triethylene glycol, propylene glycol, or combinations thereof. The color-change agent composition may comprise from 1-10 wt % of the humectant, based on the total weight of the a) color-change agent composition. The a) color-change agent composition may comprise at least 1, 2, 3, 4, 5, 6, 7, 8, or at least 9 wt % of the humectant, based on the total weight of the a) color-change agent composition. The a) color-change agent composition may comprise at most 10, 9, 8, 7, 6, 5, 4, 3, or at most 2 wt % of the humectant, based on the total weight of the a) color-change agent composition.

### b) One or More Ink Compositions

According to an embodiment of the marking system, the b) one or more ink compositions are disposed on a substrate. Non-limiting examples of suitable substrates are paper, wood, other cellulosic substrates (e.g. cardboard and the like), fabric, glass, plastic, metal, ceramic, cement, etc. Paper or cardboard are preferred.

According to an embodiment, the marking system comprises two or more ink compositions b), such that each respective ink color of the two or more ink compositions b) is the same, and at least one of more of the respective second colors is different from the other of the respective second colors.

According to another embodiment of the marking system, the b) one or more ink compositions each comprise from 60% to 95% of the respective i) first dye composition and from 5% to 40% of the respective ii) second dye composition, based on the total weight of the respective i) first dye composition and the respective ii) second dye composition. It is not necessary that each of the respective one or more ink compositions contain the same relative amounts of each respective i) first and ii) second dye compositions.

According to an embodiment, the b) one or more ink compositions may further comprise at least one binder. Non-limiting examples of suitable binders are emulsified polymers, such as acrylics and copolymers thereof. The b) one or more ink compositions may each comprise up to 50 wt % of the at least one binder, based on the total weight of each b) ink composition, exclusive of any solvent or carrier.

According to an embodiment the b) one or more ink compositions further comprise at least one thickener. The thickener, if present, is preferably compatible with any binder, if present. Non-limiting examples of suitable thickeners are hydroxyethyl cellulose, associative thickeners such as nonionic polyurethane associative thickeners, anionic associative thickeners and the like, or combinations thereof. The b) one or more ink compositions may each comprise from 1-15, 2-9 wt %, or from 5-10 wt % of the thickener, based on the total weight of each b) ink composition, exclusive of any solvent or carrier.

i) Dye Composition that Reacts with the Color-Change Agent Composition:

According to an embodiment, the i) at least one first dye composition comprises pyranine 120, acid green 3, acid violet 19, basic blue 93, basic yellow 49, or a combination thereof.

According to an embodiment, the i) at least one first dye composition comprises a dye that intensifies in color when contacted with the a) color-change agent composition.

Nonlimiting examples of suitable i) dyes that react with the a) color-change agent composition include triarylmethane dyes, triphenylmethane dyes, cyanine dyes, methine dyes, basic blue 1, basic blue 5, basic violet, basic violet 3, acid violet 17, acid violet 9, acid violet 49, acid green 3, acid green 9, basic red 14, basic red 15, basic red 16, basic orange 21, acid violet 19, acid blue 93, basic yellow 49, basic red 14, basic blue 69, basic green 4, pyranine 120, or combinations therefore.

ii) Dye Composition that does not React with the Color-Change Agent Composition:

According to an embodiment, the ii) at least one second dye composition comprises acid yellow 23, acid red 18, acid red 87, patent/food blue 5/AB3, or a combination thereof.

Non-limiting examples of dyes that do not react with the color-change agent composition include patent/food blue 5/AB3, acid blue 9, acid red 1, acid red 18, acid red 87, acid yellow 23, acid yellow 36, FD&C Yellow 6, or combinations thereof.

### Other Additives:

Other additives may also be included in the a) color-change agent composition and/or the b) one or more ink compositions. These include, but are not limited to stabilizers, preservatives, defoamers, or combinations thereof.

Non-limiting examples of suitable preservatives are Mergal® (Troy), or Reputain® (Lonza).

### Methods:

Also provided is a method of marking a substrate with the marking system. The method comprises the following steps.
A) Providing the substrate comprising an ink layer formed from the b) one or more ink compositions and having a respective ink color; and
B) applying the a) color-change agent composition to at least a portion of the ink layer to react with each respective i) first dye composition to produce the respective second color, different from each respective ink color.

According to some embodiments, the ink layer may be applied to the substrate using printing methods as are known and used in the art. Non-limiting examples are inkjet printing, color laser printing, screen printing, offset lithography, digital printing, or flexography.

Certain aspects of the invention may be summarized as follows. (Claims as multiple dependent Aspects when completely finalized.)

### Examples

The following color-change agent composition and three initially black ink compositions were prepared. In use, the ink compositions 1, 2, and 3 were printed on a paper substrate in a pattern and allowed to dry to form an ink coating. The paper therefore appeared to be uniformly black, prior to application of the color-change agent composition. When the color-change agent composition was applied to the black ink coating, a pattern of red, yellow and blue was revealed.

In other experiments, the three ink compositions are blended to form other secondary colors such as orange, green and purple when the ink coating is contacted with the color-change agent composition.

Color-change agent composition (colorless)

| Ingredient | wt % |
|---|---|
| Deionized Water | 69.8 |
| Sodium Hydroxide, 25 wt % | 1.8 |
| Sodium Sulfite | 10 |
| Glycerin | 4 |
| Sodium Carbonate | 6 |
| Surfactant Solution (30 wt %) | 3 |
| Citric Acid | 0.4 |
| Stabilizer | 5 |

Ink compositions

| | Ink composition | 1 | 2 | 3 |
|---|---|---|---|---|
| | First color | Black | Black | Black |
| | Second color | Red | Blue | Yellow |
| | (after contacting color- | | | |
| | change agent composition) | | | |
| | Ingredient | wt % | wt % | wt % |
| | Water | 66.70 | 68.20 | 68.58 |
| First dye | Acid Green 3 * | 6.70 | 6.70 | 6.00 |
| composition i) | Acid Violet 19 * | 0.50 | 1.76 | 1.76 |
| (reacts with | Basic Blue 93 * | 1.00 | — | — |
| color-change | Basic Yellow 49 * | 1.00 | 0.38 | — |
| agent | Pyranine 120 (yellow)** | — | — | 1.50 |
| composition) | | | | |
| Second dye | Acid Yellow 23 | — | — | 1.00 |
| composition ii) | Acid Red 18 | 1.50 | — | — |
| (does not react | Acid Red 87 | 1.50 | — | — |
| with color- | Patent/Food Blue 5/AB3 | — | 1.50 | — |
| change agent | | | | |
| composition) | | | | |
| | preservative | 1.16 | 1.16 | 1.16 |
| thickener | Cellosize ™ (5% in water) | 20.00 | 20.00 | 20.00 |

* reacts with color-change agent composition and becomes colorless
**reacts with color-change agent composition and intensifies in color

What is claimed is:

1. A marking system comprising:
a) a color-change agent composition; and
b) one or more ink compositions each having a respective ink color, each respective ink composition comprising a respective:
i) at least one first dye composition characterized by a respective first color, the at least one first dye composition configured to react with the color-change agent composition; and
ii) at least one second dye composition configured to not react with the color-change agent composition characterized by a respective second color;
such that when the a) color-change agent composition contacts the b) one or more ink compositions, each respective i) at least one first dye composition reacts with the a) color-change agent composition, thereby producing each respective second color, wherein each respective first color is different from each respective second color, and wherein each respective second color is different from each respective ink color.

2. The marking system of claim 1, wherein the b) one or more ink compositions are disposed on a substrate.

3. The marking system of claim 1, wherein the a) color-change agent composition is aqueous.

4. The marking system of claim 1, wherein the a) color-change agent composition is disposed in an applicator.

5. The marking system of claim 1, comprising two or more ink compositions b), wherein each respective ink color of the two or more ink compositions b) is the same, and wherein at least one of more of the respective second colors is different from the other of the respective second colors.

6. The marking system of claim 1, wherein the b) one or more ink compositions each comprise from 60% to 95% of the respective i) first dye composition and from 5% to 40% of the respective ii) second dye composition, based on the total weight of the respective i) first dye composition and the respective ii) second dye composition.

7. The marking system of claim 1, wherein the b) one or more ink compositions further comprise at least one thickener.

8. The marking system of claim 1, wherein the b) one or more ink compositions further comprise at least one binder.

9. The marking system of claim 1, wherein the a) color-change agent composition comprises:
iii) at least one solvent,
iv) at least one reactive agent reactive with the i) at least one first dye composition.

10. The marking system of claim 9, wherein the a) color-change agent composition further comprises:
v) at least one pH adjuster.

11. The marking system of claim 9, wherein the a) color-change agent composition further comprises:
vi) at least one buffer.

12. The marking system of claim 9, wherein the a) color-change agent composition further comprises:
vii) at least one wetting agent.

13. The marking system of claim 9, wherein the a) color-change agent composition further comprises:
viii) at least one surfactant.

14. The marking system of claim 9, wherein the a) color-change agent composition further comprises:
ix) at least one humectant.

15. The marking system of claim 9, wherein a pH of the a) color-change agent composition is 8 or higher.

16. The marking system of claim 1, wherein the i) at least one first dye composition comprises triarylmethane dyes, triphenylmethane dyes, cyanine dyes, methine dyes, basic blue 1, basic blue 5, basic violet, basic violet 3, acid violet 17, acid violet 9, acid violet 49, acid green 3, acid green 9, basic red 14, basic red 15, basic red 16, basic orange 21, basic yellow, acid violet 19, acid blue 93, acid green 3, basic yellow 49, basic red 14, basic blue 69, basic green 4, pyranine 120, or a combination thereof.

17. The marking system of claim 1, wherein the ii) at least one second dye composition comprises patent/food blue 5/AB3, acid blue 9, acid red 1, acid red 18, acid red 87, acid yellow 23, acid yellow 36, and FD&C Yellow 6, or a combination thereof.

18. The marking system of claim 1, wherein the i) at least one first dye composition comprises a dye that intensifies in color when contacted with the a) color-change agent composition.

19. A method of marking a substrate with the marking system of claim 1 comprising:
A) providing the substrate comprising an ink layer formed from the b) one or more ink compositions and having a respective ink color; and
B) applying the a) color-change agent composition to at least a portion of the ink layer to react with each respective i) first dye composition to produce the respective second color, different from each respective ink color.
